(19) United States
(12) Patent Application Publication
(10) Pub. No.: US 2005/0017464 A1
(43) Pub. Date: Jan. 27, 2005

(54) Bi-directional sliding board

(76) Inventors: Charles Mehrmann, Lynnwood, WA (US); Brian Vehige, Seattle, WA (US)

Correspondence Address: KOLISCH HARTWELL, P.C., 520 S.W. YAMHILL STREET, SUITE 200, PORTLAND, OR, 97204, US

(21) Appl. No.: 10/863,912

(22) Filed: Jun. 8, 2004

Related U.S. Application Data
(63) Continuation of application No. 10/037,522, filed on Jan. 4, 2002, now abandoned.

(51) Int. Cl. B62B 13/00

(52) U.S. Cl. 280/18

(57) ABSTRACT

The invention features a sliding device, such as a sledboard, having upwardly turned ends at each end of the board, so as to be ridden with either end of the device facing in the leading direction, i.e., when used on a downward slope, in the downhill direction. The sliding device has both an upturned leading end and an upturned trailing end. The sliding device is thereby able to spin around and is able to ride in both directions, enabling a rider or riders to ride backwards or forwards. These upturned or “flipped-up” ends also confer the advantage of preventing one end of the sled from acting as a brake by digging into the snow and stopping the sled. This allows the sled to travel down the hill no matter which end is facing down the hill.

This application is a continuation of U.S. patent application Ser. No. 10/037,522, which is incorporated herein by reference in its entirety for all purposes.

### BACKGROUND OF THE INVENTION

The invention relates to a sports board for sliding on snow or ice.

Due to their comfort, lightweight, and attractive designs, soft foam sled boards have become popular when sliding in a kneeling, prone, or sitting position on snow or ice. Soft foam sled boards have been prepared with a polyethylene foam core and a slick film outer skin, or “Slick skin,” that is puncture resistant and impervious to water. These boards have the advantage of a slick surface, so as to create less drag and promote quick release from the sliding surface. Nonetheless, recreational enjoyment of such boards is limited, because the boards have only a unidirectional orientation. In traditional soft foam sleds, the sled has a dedicated directional shape, so that if the sled spins around while in motion, the tail end of the sled will bite into the snow and spill the rider(s). Double ends were previously only possible on rigid boards, such as fiberglass or hard plastic boards.

### SUMMARY OF THE INVENTION

It is therefore an object of the invention to provide a double-ended sliding device that can be ridden with either end of the device facing in the leading direction, i.e., when used on a downward slope, in the downhill direction. The sliding device both has an upturned “nose,” i.e., an upturned leading end, and an upturned “tail,” i.e., or an upturned trailing end. The sliding device is thereby able to spin around and is able to ride in both directions, enabling a rider or riders to ride backwards or forwards. These upturned or “flipped-up” ends also confer the advantage of preventing one end of the sled from acting as a brake by digging into the snow and stopping the sled. This allows the sled to travel down the hill no matter which end is facing down the hill.

By “sliding device” is meant a runnerless sled, commonly referred to as, for example, a toboggan.

The longitudinal sides of the sled can be straight. Alternatively, the sides of the sled can be shaped so as to permit the sled to curve when the side of the sled is engaged into the snow. Preferably, the sides of the sled are shaped with one or more concave curves or with one or more convex curves. The curvature(s) on the two sides of the sleds can be symmetrical. Alternatively, the curvature(s) on the two sides of the sleds are asymmetrical. Optionally, the sides of the sled can be curved so as to give the sled a snowboard-like appearance.

In one embodiment, the sliding device can have a shape similar to a traditional freestyle snowboard, but in contrast to a snowboard which is made to be used in a standing position, the sliding device of the invention is intended for a kneeling, prone, or seated user, because the sled does not require the stiffness and rigidity necessitated by a standing rider. The sliding device of the invention can have a soft foam construction. These boards of the invention have a foam core and are “soft boards.”

Preferably, the sliding device has one or more handgrips or handles. More preferably, the sliding device has a pair of handles on opposite sides of the sled to which a rider may hold during use. In another embodiment, the sliding device has two or more pairs of handles, so as to be held by two or more riders seated together on the sled. Where the sliding device has a plurality of handgrips, the handgrips can be positioned for use by riders facing the same direction, or for use by riders facing opposite directions, or for riders to face in interchangeable directions.

### BRIEF DESCRIPTION OF THE DRAWINGS

FIG. 1 is a perspective view from above the sled board of the invention.

FIG. 2 is an illustration of the top side of an embodiment of the sled board of the invention.

FIG. 3 is an illustration of the bottom side of an embodiment of the sled board of the invention.

FIG. 4 is a side view of the sled board shown in FIGS. 1 and 2.

FIG. 5 is a side view of an alternative embodiment of a sled board of the invention.

### DETAILED DESCRIPTION

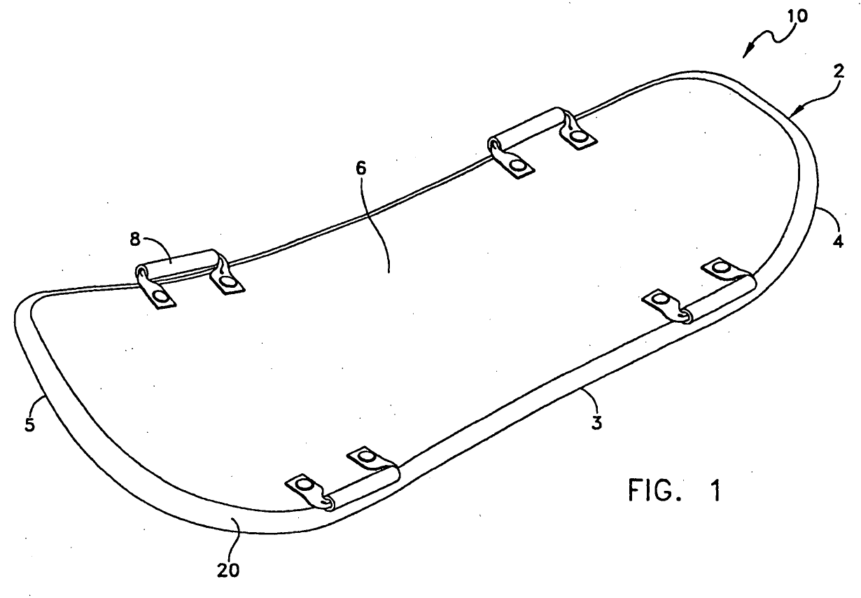

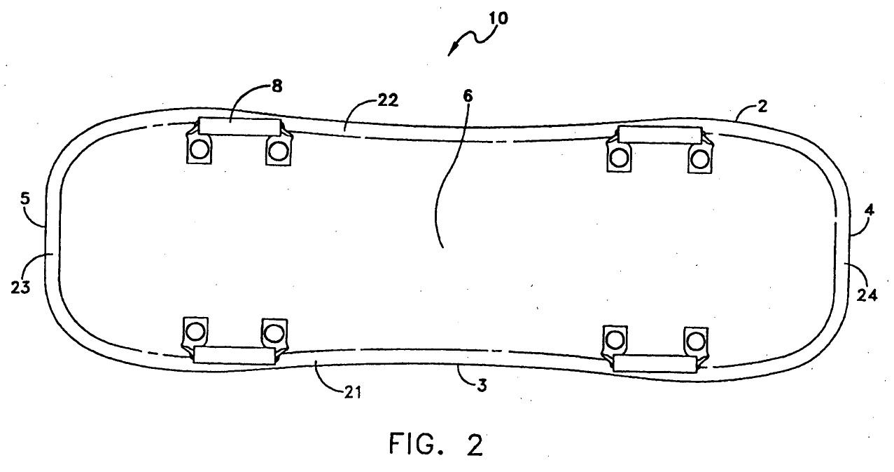

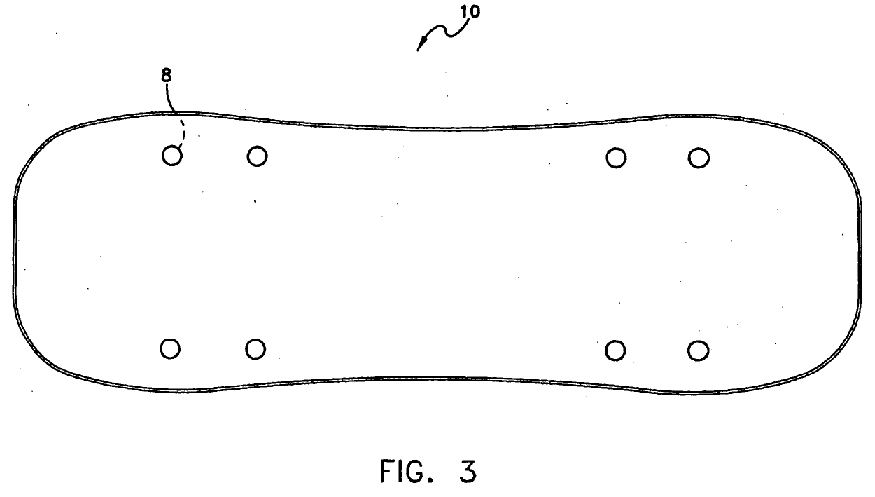

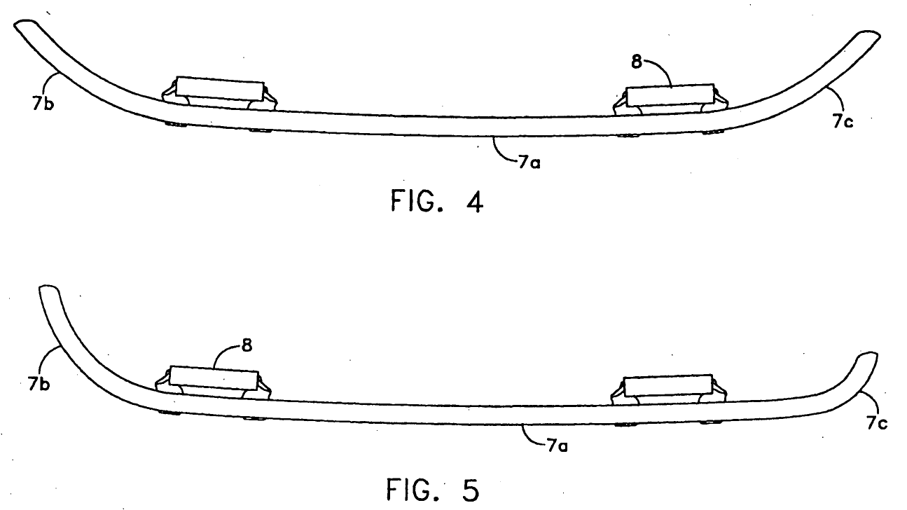

Referring generally to FIGS. 1-5, a sliding device of the present invention is shown generally at 10. Sled board 10 typically includes an elongate member 2 configured to slide over a sliding surface, such as snow, ice, grass, metal, water slide, or any sufficiently slippery surface. Elongate member 2 includes a substantially flat intermediate portion 3, and opposite upturned end portions 4 and 5, where, in use, end portion 4 is the leading end portion and end portion 5 is the trailing end portion. These ends are interchangeable. Leading and trailing end portions 4 and 5 each include a respective inward end that is positioned adjacent a corresponding outer end of intermediate portion 3. Leading and trailing end portions 4 and 5 typically each extend outward from the intermediate portion 3 in a continuously curved shape. Alternatively, either or both of the leading and trailing end portions 4 and 5 may be polygonal or may have another curved shape or may have a discontinuously curved shape. The upturned end portion can have a radius of curvature or, alternatively, may be kinked. Preferably, the upturned end portions 4 and 5 are symmetric with each other. Alternatively, the upturned end portions may be formed in different shapes or may be asymmetrically shaped.

Elongate member 2 includes a top surface 6 and a bottom surface 7. The bottom surface 7 includes a substantially planar bottom region 7b, typically extending along a bottom side of intermediate portion 3 of the elongate member 2. Bottom surface 7 further includes a leading upturned bottom region 7b and a trailing upturned bottom region 7c, each extending along an underside of upturned end portions 4 and 5, respectively. Typically, both the leading upturned bottom region 7b, and the trailing upturned bottom region 7c, are shaped in a continuous curve originating at an inward end of the respective upturned bottom region, which is positioned at the intersection of the respective upturned bottom region 7b, 7c, and the substantially planar bottom region 7a. Alternatively, the upturned bottom regions may be straight, polygonal, or curved in another shape.

As shown in FIG. 1, elongate member 2 is surrounded by an outer edge 20, which includes left and right side edges 21 and 22, and leading and trailing end edges 23 and 24. Side edges 21 and 22 are substantially coplanar with intermediate portion 3, while, due to the upturn in end portions 4 and 5, end edges 23 and 24 are higher than the plane of intermediate portion 3. Preferably, end edges 23 and 24 are at least one inch higher than intermediate portion 3, for example, 6 inches higher, or even 2 inches higher, or 5 or 10 inches higher.

Typically, the outer edge 20 is rounded in the region of leading and trailing end edges 23 and 24. Alternatively, the end edges 23 and 24 may be straight, or polygonal, or any desired shape.

Typically, outer edge 20 is straight in the region of left and right side edges 21 and 22. Alternatively, the sides of the sled may be shaped so as to permit the sled to curve when the side of the sled is engaged into the snow. Preferably, side edges 21 and 22 are shaped with one or more concave curves. Alternatively, side edges 21 and 22 have one or more convex curves or have a combination of concave curves and convex curves.

The curvature(s) on the two sides of the sleds can be symmetrical. Alternatively, the curvature(s) on the two sides of the sleds are asymmetrical. Optionally, the sides of the sled may be curved so as to give the sled a snowboard-like appearance.

Elongate member 2 typically includes a bevel 15 along its outer edge 20. Alternatively, it will be appreciated that elongate member 2 may not include any bevel at all.

Elongate member 2 is typically made of a relatively low-density foam material, including but not limited to polyethylene, polypropylene, R-cell, and polystyrene. Optionally, the board can be made substantially as described in U.S. Pat. No. 4,850,913, issued Jul. 25, 1989, hereby incorporated by reference. For example, in one embodiment of the invention, elongate member 2 is a polyethylene foam board having a shaped core of closed-cell polyethylene foam planking, preferably with a density of about 1 to 10 pounds per cubic foot (pcf), more preferably, a density of about 2 to 4 pcf. The core can either be made from a single piece of foam planking cut to shape, or it can be composed of a laminate of a plurality of foam sheets either heat laminated to each other, or laminated by other methods known in the art such as polyethylene film lamination. A laminated core is cut to shape similarly to a one-piece core.

The sled board of the invention has a slippery, i.e., slick, outer skin over substantially all of bottom surface 7 and, optionally, over part or all of outer edge 20. The slick surface on the underside and outer edge of the board creates less drag and promotes quick release from the sliding surface. The slick skin gives the board improved performance, superior cosmetic appearance, ability to receive permanent color impregnation of a logo, ability to receive dry adhesive traction material, decreased water absorption by the board, and other benefits.

Preferably, the slick skin, or “Slick skin” is a thin sheet of polyethylene or similar plastic of, for example, Syrlin. The sheet of skin 10-25 mil can be extruded onto a ⅛ inch sheet of foam (commonly 4#-8# polyethylene). Alternatively, the 10-25 mil film can be extruded directly onto the core material without first extruding it to the 4#-8# foam backing. The polyethylene film, which forms the outer skin of the board, is suitably about 1 to 100 mils in thickness and preferably about 10 to 50 mils in thickness. This film can be extruded onto a polyethylene closed-cell foam sheet having a density of about 1 to 10 pcf, preferably about 4 to 8 pcf, and most preferably about 6 pcf. The film may be clear or may be colored during its manufacture. The film is extruded to the foam sheet at about 400° F., as known in the art, and the film/foam laminate is air cooled and taken up on rolls.

The slick skin (the ⅛ inch foam sheet and skin combination) is then laminated onto a core, typically a rectangular core, composed of lower density material, including but not limited to polyethylene, polypropylene, R-cell, -or polystyrene. The foam core and the film/foam laminate are then each heated to about 400° F. on the foam surfaces to be laminated together. The closed-cells on these surfaces open under the influence of heat, and the surfaces are brought together under compression. The heat and pressure enable a laminate to be formed. The core is then reversed, and the unlaminated side is heated and another sheet of film/foam laminate is similarly laminated thereto. A film/foam sheet is subsequently laminated to the exposed side edges of the board, thus substantially encasing the core in film/foam laminate, or the top sheet is left large enough to wrap the sides. The edge strips or top sheet wrap are also applied by heat lamination and compression. The pressure may be applied by hand, iron, roller or other method known in the art. The board is air-cooled.

Conversely, this skin could be extruded directly onto the core material, without first extruding onto the ⅛ inch carrier sheet of foam. Once the core and the skin are bonded, the plan shape, the sled from the top view, is fashioned, and the core is contoured to create, for example, rounded sides, or a dished middle, or shaped in such a way as to create a pocket to hold the rider. This inherently flat core and skin is then laminated or bonded to the top deck which can be polyethylene, but can also be nylon, polyester, polypropylene, Microcell, or elastomeric metallocene rubber (EMR). As the board emerges from the rollers in its hot malleable state, the nose is curved up and allowed to cool into shape, and the same is done with the tail, creating the upturned or “kicked up” nose and tail. The perimeter is then finished off by heat lamination and is trimmed, creating the finished sled. Heat stamps are then applied, and handles 8 are affixed by methods known to those skilled in the art, so as to complete the product.

Preferably, the slick-skin surface is only on the bottom of the board. The upper surface of the board comes in sheet form, ⅛ to 3/16 inch thick. It is 4# polyethylene foam. The sheet is simply laminated onto the core, and the sides are heat laminated by hand around the sides. Any embossing is then put into the skin. Another alternative method is to pre-emboss or vacuum-form the sheet and then laminate it to the Be.

Color patterns may optionally be incorporated into the film/foam laminate by adding color concentrate in a pattern configuration to the film surface immediately prior to lamination to the foam sheet. This provides a similar pattern configuration on the board. For example, the color may be applied between the film and foam during the lamination process when the film and foam sheets have both been unwound from rolls and exposed to heat and are traveling toward the nip of pressure rolls. As the heated sheets pass through the nip of the pressure rolls, heat lamination takes place. Color concentrate added onto the surface of the film is spread to form an elongated pattern of stripes of waves on the board. Varying colors may be used in combination.

The completed board may have the same or differently colored skins on its outer surface according to choice. The outer polyethylene film skins are slick to the touch and glossy in appearance and are substantially impervious to the elements.

A logo may be permanently applied to the deck and/or bottom of the board. In a non-limiting example, a logo may be permanently applied to the polyethylene film outer layer, using heat and pressure on a Mylar transfer pattern made especially for applying to polyethylene. (Mylar is a polyester film made by E.I. DuPont & Company, Ltd.) A foam board of the invention is slick to the touch and particularly when it is wet, the board is slippery to feel. In order to provide good frictional adhesion, dry adhesive traction material or wax may be applied. The dry adhesive traction material is particularly suitable for applying to the top deck of the board, either substantially over the whole surface of the deck or in particular areas, as appropriate. Dry adhesive or wax may also be applied around the edges of the board to facilitate handling. Traction material on the board facilitates a good grip by the user without impairing the functional advantages of the slick surfaces of the board. Dry adhesive material, which may be sheet material having a watertight frictional surface with a backing of the dry adhesive material, may be removed from the board surface and replaced, if necessary, without damaging the slick, glossy surface of the board. Suitable dry adhesive is made by Astro-Deck and Trac-Top.

The materials and design of the board combine synergistically to provide a slick board with excellent performance characteristics since frictional resistance is decreased and loss in velocity as the board moves through the medium is minimized by use of the glossy, non-absorptive surface. The slick polyethylene film skin is resistant to puncturing and impervious to water. Water absorption by a board of the invention is substantially decreased over that of known boards.

Appropriate materials for the core also include polyethylene foam, polypropylene foam, polyurethane foam, and Arcel foam (made by Atlantic Richfield Co.). Polyethylene foam is the preferred material. The outer film sheet is preferably polyethylene film laminated to a sheet of polyethylene foam. The polyethylene foam sheet provides strength and cushioning to the film, and the slick skin formed from the film is laminated to the core of the board to provide a board having a smooth, glossy surface which glides easily through snow, or other surfaces.

The performance characteristics of the board may be varied by varying the density of the foam core, foam sheet and/or film, as known to one skilled in the art. For example, a sliding device can have a 30-mil thickness of polyethylene film forming the skin on the deck of the board and on the bottom of the board, and a 15-mil thickness of film as the outer glossy surface on the edges of the board. A stiffer board is provided if either the foam core has a greater density and/or if the film skins have a greater density and/or thickness. The degree of flex of the board is also controllable by varying the thickness of the foam core and skin, a greater degree of flex being provided by use of less dense foams and thinner films. In particular, thickness of the film outer skin is determinative of flexibility of the board.

In balancing the properties required, the strength of the product must also be considered, and in general, heavier, thicker materials provide the advantage of greater strength, but the disadvantage of greater weight and stiffness.

While the invention has been described above with respect to certain embodiments thereof, it will be appreciated that variations and modifications may be made without departing from the spirit and scope of the invention.

1. A sliding device comprising:
an elongate member having a soft foam core, an upper surface and a bottom surface, the bottom surface having a slick skin, and the elongate member including:
an intermediate~portion having a substantially planar bottom region configured to slide over snow;
substantially symmetrical elongate concave side edges; and
two end portions, each of the end portions having an upturned shape so as to enable the sliding device to be ridden on a downward slope with either one of the end portions acting as the leading end; and
a plurality of handles, each handle having two ends and a connecting piece therebetween, with each of the two ends mounted to the upper surface of the elongate member with sufficient space for a gloved hand between the connecting piece and the upper surface of the elongate member.
